(19) United States
(12) Patent Application Publication
(10) Pub. No.: US 2006/0234067 A1
(43) Pub. Date: Oct. 19, 2006

(54) Laser gilding film containing curing coating and manufacture thereof

(75) Inventor: Yao-Hui Lu, Hsinchu (TW)

Correspondence Address: BRUCE H. TROXELL, SUITE 1404, 5205 LEESBURG PIKE, FALLS CHURCH, VA, 22041, US

(73) Assignee: Klaser Technology Inc.

(21) Appl. No.: 11/106,560

(22) Filed: Apr. 15, 2005

(51) Int. Cl. B32B 15/04; B32B 15/20; C25D 3/00

(52) U.S. Cl. 428/457; 205/261; 428/698

(57) ABSTRACT

A laser gilding film containing a curing coating and manufacture thereof comprises the following steps: spreading a curing coating layer that is not hermetically sealed to a plastic film onto one face of the plastic film; sticking the curing coating layer to a mold with laser lines; solidifying the curing coating layer and separating the mold after laser lines corresponding to the laser lines is formed thereon; electroplating a layer of metal layer on the curing coating layer with the laser lines; and spreading a heat melt glue layer on the metal layer 33 to form a laser gilding film.

### FIELD OF THE INVENTION

The present invention relates to a laser gilding film with a laser pattern, and more particularly to a laser gilding film containing a curing coating and manufacture thereof.

### DESCRIPTION OF RELATED ART

The U.S. patent Pub. No. 20040241404 discloses a paper with holographic pattern and manufacture of it, in which a separation type metallized holographic image is caused to transfer from a mother film to a paper by means of illumination combination of UV resin and UV light. Because an UV illumination facility is needed according to the patent application to combine a metallized holographic image onto a paper, the application of the gilding film with the metallized holographic image is limited.

The U.S. Pat. No. 5,939,177 discloses a holographically transferable image in which a heating and pressuring is used to transfer a metallized holographic image spread with an adhesive layer onto a package paper to cause the package paper to have a holographic image thereon. The metallized holographic image stuck on the package paper according to the patent has no protective film; an extra work must be done to generate a protective film, this will increase a working hour.

The U.S. Pat. No. 6,558,788 disclosed a holographic transfer film. A holographic image is disposed at the outer layer of a transfer film and a metal film is electroplated on the outer layer with the holographic image. A glue or adhesive is spread on a carrier to stick a metal film with a holographic image to cause the metal film with the holographic image to be transferred from the transfer film to the carrier. The metallized holographic image stuck on the package paper according to the patent has no protective film too; an extra work must be done to generate a protective film, this will increase a working hour.

Please refer to FIGS. 1A and 1B. The figures show a conventional laser gilding film 10 with a laser pattern. In the figures, a separation layer 12 is spread on one face of a plastic film 11, a laser pattern layer 13 is then made on the separation layer 12, a metal layer 14 is electroplated on the laser pattern layer 13, a heat melt glue layer 15 is spread on the metal layer, and the laser gilding film 10 is finally formed, as FIG. 1A shows. When the conventional laser gilding film 10 with a laser pattern is used, a carrier 20 is stuck on one face thereof at which the heat melt glue layer 15 is disposed, the heat melt glue layer 15 and the carrier 20 are firmly bonded by means of heating and pressuring. Because it is not firmly bonded between the separation type layer 12 and the laser pattern layer 13 and firmly bonded between the laser pattern layer 13 and the metal layer 14, the laser pattern layer 13 is allowed to be easily separated from the separation layer 12 and the plastic film 11 to cause the carrier 20 to have a metallized image. Here, the laser pattern layer 13 has the metal layer 14 protecting effect.

A separation type layer 12 needs to be spread between the plastic film 11 and the laser pattern layer 13 when the laser gilding film 10 mentioned above is manufactured, the manufacturing processes are rather complex and the manufacturing materials, time and cost are rather consumed.

### SUMMARY OF THE INVENTION

For providing a laser gilding film containing a curing coating and manufacture thereof and enabling the manufacturing processes to be simplified so as to save the production time and cost, the present invention is proposed.

The main object of the present invention is to provide a laser gilding film containing a curing coating and manufacture thereof, enabling the manufacturing processes to be simplified and the production time and cost to be rather saved.

Another object of the present invention is to provide a laser gilding film containing a curing coating and manufacture thereof, capable of simplifying the structure and saving the materials.

### BRIEF DESCRIPTION OF THE DRAWINGS

The present invention can be more fully understood by reference to the following description and accompanying drawings, in which:

FIGS. 1A to 1B are schematic views, showing a structure of a conventional laser gilding film and an application thereof;

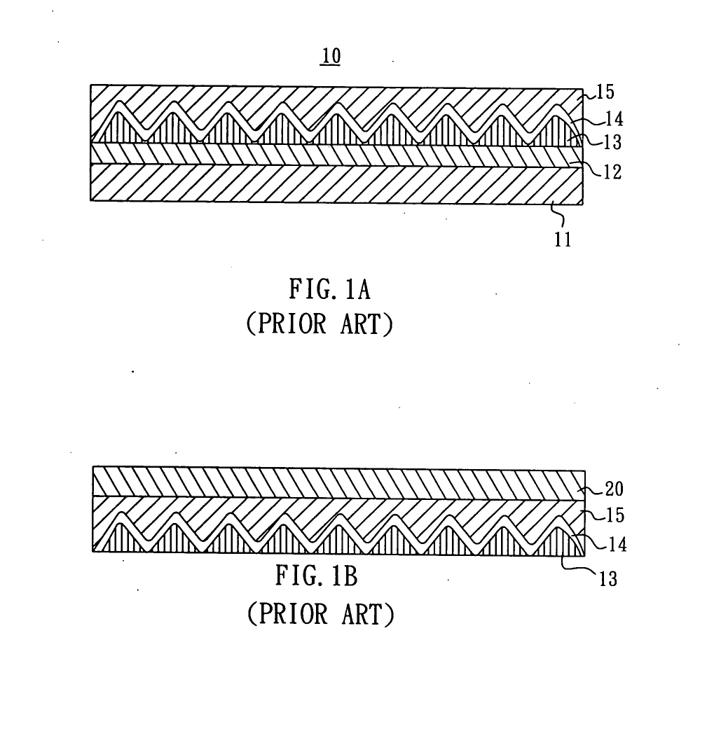

FIGS. 2A to 2E are schematic views, respectively showing a structure at each step according to a method for manufacturing a laser gilding film of the present invention; and

FIGS. 3A and 3B are schematic views, showing a structure of a laser gilding film and an application thereof according to the present invention.

### DETAILED DESCRIPTION OF THE PREFERRED EMBODIMENTS

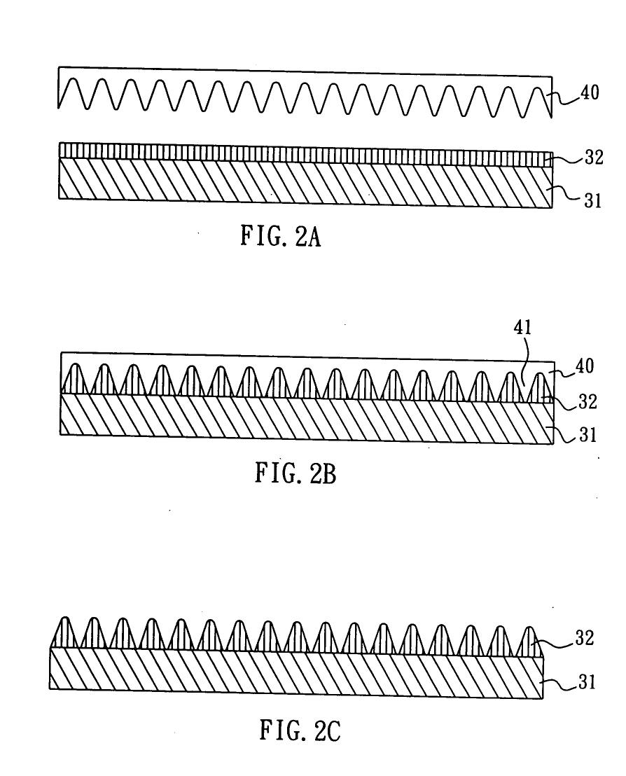

Please refer to FIGS. 2A to 2E. A laser gilding film containing a curing coating and manufacture thereof according to the present invention comprises the following steps:
(1) spreading a curing coating layer 32 that is not hermetically sealed to a plastic film 31 onto one face of the plastic film 31 to allow the curing coating layer 32 to be fictitiously attached on the plastic film 31, as FIG. 2A shows;
(2) sticking the curing coating layer 32 to a mold 40 with laser lines 41, as FIG. 2B shows;
(3) solidifying the curing coating layer 32 and separating the mold 40 after laser lines corresponding to the laser lines 41 is formed thereon, as FIG. 2C shows;
(4) electroplating a metal layer 33 on the curing coating layer 32 with the laser lines, as FIG. 2D shows; and
(5) spreading a heat melt glue layer 34 on the metal layer 33, as FIG. 2E shows, and a laser gilding film is formed.

A material of the curing coating layer 32 can be a UV curing coating or electron beam curing coating. The mold 40 mentioned above can be a holographic laser film or holographic laser impressing wheel. After the curing coating layer 32 is caused to stick on the mold 40 and illuminated with UV light or an electron beam to solidify the curing coating layer 32, and it is then separated from the mold 40. The electroplated metal layer 33 is formed by processing vacuum electroplating with a metal material such as aluminum or zinc sulfide.

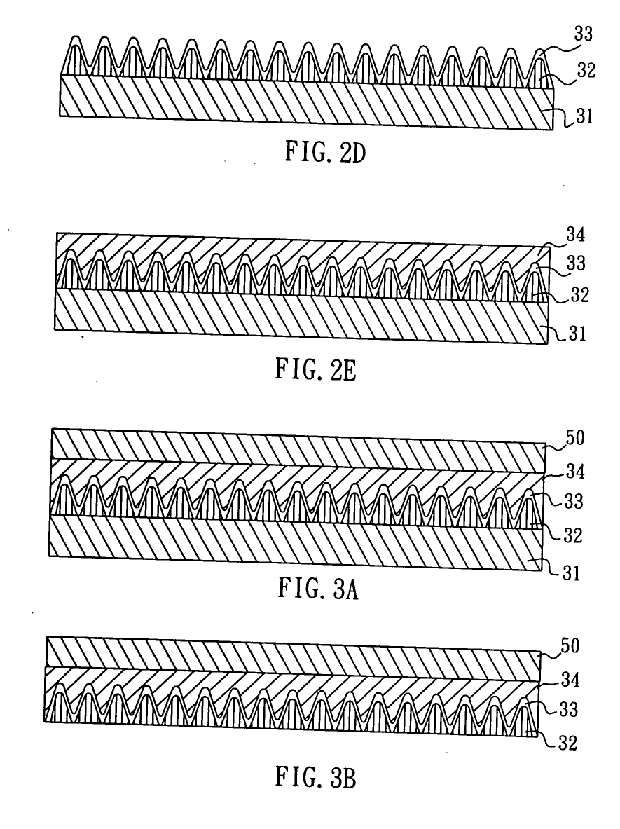

Please refer to FIGS. 3A and 3B. When the laser gilding film according to the present invention is used, a carrier 50 is stuck on one face of the laser gilding film disposed with the heat melt glue layer 34 and the heat melt glue layer 34 is caused to stick firmly with the carrier 50 by means of heating and pressuring. Because it is not firmly bonded between the curing coating layer 32 and the plastic film 31 and firmly bonded between the curing coating layer 32 and the metal layer 33, the curing coating layer 32 is allowed to be easily separated from the plastic film 31 to cause the carrier 50 to have a metallized image. Here, the curing coating layer 32 has the metal layer 33 protecting effect.

A separation type layer is unnecessary to be spread between the plastic film 31 and the curing coating layer 32 of the laser gilding film containing the curing coating layer according to the present invention.

The laser lines 41 on the mold 40 of the present invention can be the lines of characters or/and a pattern to allow the gilding film to have the image of characters or/and a pattern. The laser lines 41 are also allowed not to appear on the mold 40 according to the present invention to cause the gilding film have no image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for forming a gilding film containing a curing coating, comprising:
(1) spreading a curing coating layer that is not hermetically sealed to a plastic film onto one face of said plastic film;
(2) sticking said curing coating layer to a mold with laser lines;
(3) solidifying said curing coating layer and then separating said mold;
(4) electroplating a metal layer on said curing coating layer; and
(5) spreading a heat melt glue layer on said metal layer so as to form a laser gilding film.

2. The method according to claim 1, wherein said mold has laser lines thereon and said curing coating layer is stuck with said laser lines so as to cause said curing coating layer to have laser lines corresponding to said laser lines after said curing coating layer is solidified.

3. The method according to claim 1, wherein a material of said curing coating layer is an UV curing coating in said step (3); wherein said UV curing coating is illuminated with UV light to solidify.

4. The method according to claim 1, wherein a material of said curing coating layer is an electron beam curing coating in said step (3); wherein said electron beam curing coating is illuminated with an electron beam to solidify.

5. The method according to claim 1, wherein said electro plating in said step (4) is vacuum electroplating.

6. A gilding film containing a curing coating, being formed by the method according to claim 1, comprising a curing coating layer being combined with one face of a plastic film, said curing coating layer is not hermetically sealed to said plastic film; another face of said curing coating layer being combined with a metal layer; another face of said metal layer being combined with a heat melt glue layer.

7. The gilding film according to claim 6, wherein said curing coating layer has laser lines, said laser lines are combined with said metal layer.

8. The gilding film according to claim 6, wherein a material of said curing coating layer is a UV curing coating.

9. The gilding film according to claim 6, wherein a material of said curing coating layer is an electron beam curing coating.

10. The gilding film according to claim 6, wherein a material of said metal layer is aluminum.

11. The gilding film according to claim 6, wherein a material of said metal layer is zinc sulfide.
